(19) United States
(12) Patent Application Publication
(10) Pub. No.: US 2005/0207613 A1
(43) Pub. Date: Sep. 22, 2005

(54) Image processing method

(75) Inventor: Haruko Kawakami, Mishima-shi (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/801,717

(22) Filed: Mar. 17, 2004

(51) Int. Cl. G06K 9/00

(52) U.S. Cl. 382/100

(57) ABSTRACT

In an image processing apparatus, a pre-process section 101 eliminates a characteristic in original image data, which is possibly confused with a characteristic of a digital watermark, before the digital watermark is embedded. A watermark adding section 102 adds the digital watermark to still image data that is pre-processed by the pre-process section. A watermark extraction section 103 extracts the digital watermark. Thereby, a frequency component, which corresponds to a region of a frequency component to be embedded, is eliminated in advance, and the added digital watermark alone can be extracted.

### BACKGROUND OF THE INVENTION

1. Field of the Invention

The present invention relates to an image processing method for embedding a digital watermark in image data and extracting the digital watermark.

2. Description of the Related Art

There is known prior-art technology for copyright protection. That is, information, which is other than content data such as audio data or video data and is indicative of the name of the copyright holder, permission/non-permission of copy, etc., is embedded in the content data. As regards still image data, information relating to the image data, the copyright, etc., is embedded in the image data. The embedded information is read from the content data. As an example of such technology, “digital watermark” is effective. In particular, in the field of audio data and video data, the standardization and practical use of digital watermarking has been developed.

However, in the field of still image data, compared to content data, the standardization of digital watermarking methods has delayed. Under the circumstances, a relatively popular technique, which has already been practiced, is configured such that the values of low-order bits are changed, thereby embedding information. According to this technique, there is no problem as regards “soft” copy of data in file format. However, as regards hard copy, which involves use of printers, there is a danger that embedded signals may be lost due to the effect of noise or modulation characteristics.

U.S. Pat. No. 5,636,292 discloses a technique wherein multiple pits are embedded in a two-dimensional pattern. This technique is less affected by characteristics of printers, compared to the above technique.

However, there is such a danger that a pattern or a frequency component, which is originally included in image data of an original document, may erroneously be determined to be an added digital watermark. Jpn. Pat. Appln. KOKAI Publication No. 2001-313814 discloses a technique to solve this problem. A distribution of cyclical components of original image data is examined in advance, and a frequency component of a signal to be added is changed. According to this technique, the frequency distribution of original image data is checked before a digital watermark is embedded, and a frequency that appears in the original image data is not used. In this case, a cyclic component appearing on the original image data is not used. It is difficult, however, to determine whether a frequency, which is detected at the stage of reading, relates to original image data or it is added as a digital watermark. Moreover, since the frequency to be added, itself, is limited, the amount of information is restricted.

In the above-described prior-art digital watermarking technology, there are such problems that a digital watermarking may erroneously be read due to inherent characteristics of original image data, and the amount of information that can be added is restricted.

In general terms, digital watermarking technology, which is directed to still image data, is mainly applied to soft copy, which is handled in file format, rather than hard copy. In this case, there is no problem in degradation of embedded digital watermarks. In the case of hard copy, however, embedded information is read after such processing as outputting through a printer and inputting through a scanner. Degradation occurs both in the outputting step and the inputting step, and the tone expression characteristics of the printer itself may lead to an error in reading.

### BRIEF SUMMARY OF THE INVENTION

The object of an aspect of the present invention is to provide an image processing method for efficiently adding a digital watermark to image data and extracting the digital watermark.

According to an aspect of the present invention, there is provided an image processing method for adding information to image data, comprising: subjecting the image data to a predetermined process in accordance with a characteristic of the information, before the information is added; adding the information to the image data that has been subjected to the predetermined process; and extracting the information from the image data to which the information has been added.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of an aspect of the invention.

FIG. 1 is a block diagram schematically showing the structure of an image processing apparatus according to a first embodiment of the present invention;

FIG. 2 is a graph schematically showing a frequency distribution of still image data;

FIG. 3 is a graph schematically showing a frequency distribution of still image data;

FIG. 4 is a graph schematically showing a frequency distribution of still image data;

FIG. 5 is a graph schematically showing a frequency distribution in a filtering process;

FIG. 6 is a view schematically illustrating an example of an operator for executing the filtering process;

FIG. 7 is a block diagram that shows a configuration for executing reading of a digital watermark according to a second embodiment of the invention;

FIG. 8 shows an example of arrangement; and

FIG. 9 is a flow chart illustrating an operation for switching a digital watermark according to a third embodiment of the invention.

### DETAILED DESCRIPTION OF THE INVENTION

Embodiments of the present invention will now be described with reference to the accompanying drawings.

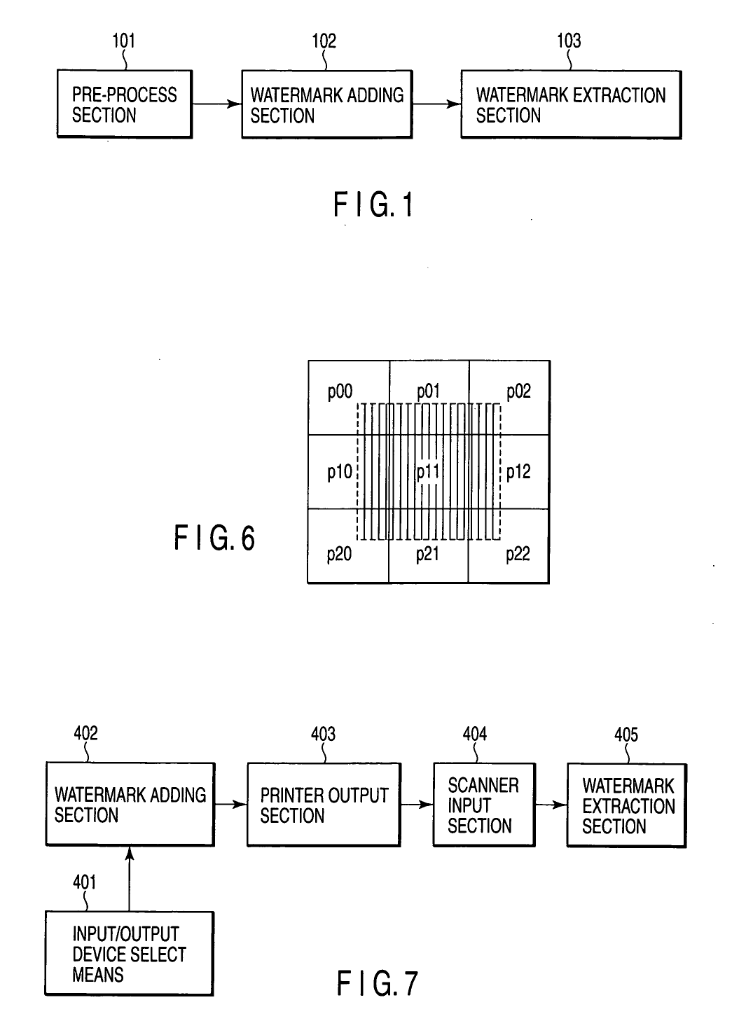

FIG. 1 schematically shows the structure of an image processing apparatus according to a first embodiment of the present invention. In FIG. 1, the image processing apparatus comprises a pre-process section 101, a watermark adding section 102 and a watermark extraction section 103. For example, the pre-process section 101 and watermark adding section 102 are provided in a multi-function peripheral, and the watermark extraction section 103 is provided in a personal computer.

As is illustrated in FIG. 1, before embedding a digital watermark, the pre-process section 101 eliminates a characteristic in original image data, which may possibly be confused with a characteristic of a digital watermark (additional information).

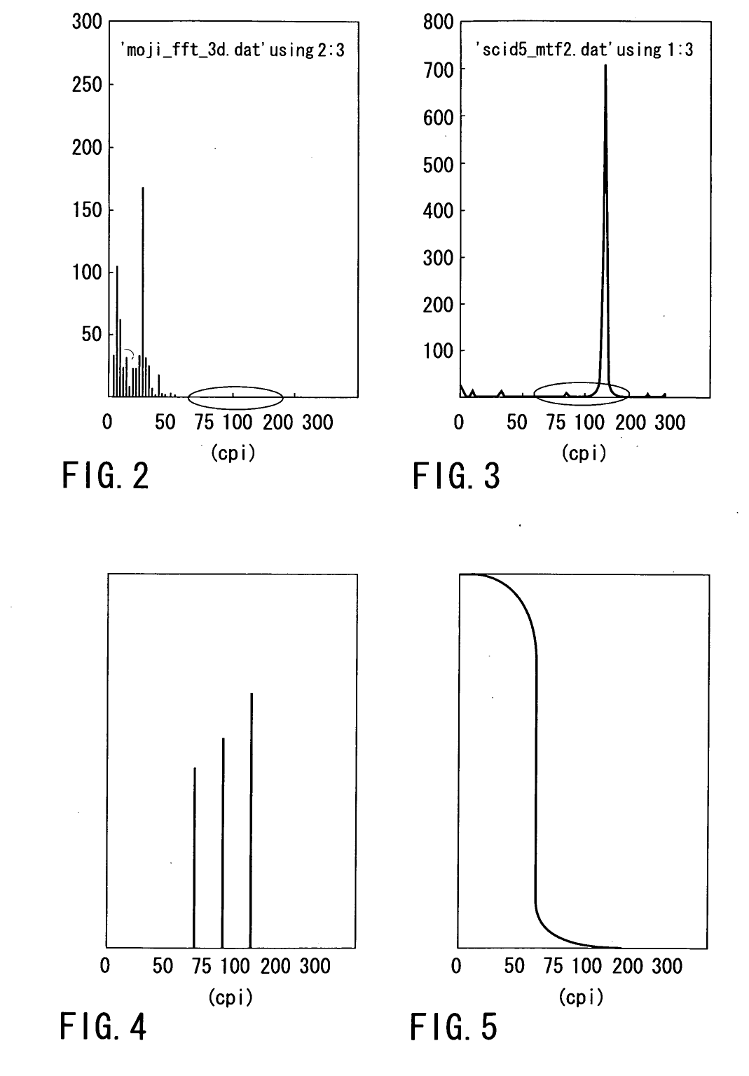

FIGS. 2 to 4 schematically illustrate examples of frequency distribution of still image data. FIG. 2 shows a cyclic component of a character original image, FIG. 3 shows a cyclic component of a halftone-screen photo original image, and FIG. 4 shows an additional component.

One of basic requirements for a digital watermark is that the digital watermark, even when it is embedded, is inconceivable and should not be unpleasant to the eye. Except for a pattern region for use in tone expression, the watermark should not overlap with cyclic component region, which occupies a major part of original image data.

Hence, even if only a cyclic component, which is an embedded object, is eliminated by a filtering process using a filter, as shown in FIG. 5, it appears that an adverse effect such as blurring of an image or a character would be very small.

FIG. 6 schematically shows an example of an operator for executing the filtering process as illustrated, for example, in FIG. 5. Assume, for example, that the Nyquist frequency of original image data, in which a digital watermark is to be embedded, is 100 cpi, and a cyclic component of 80 cpi or more is embedded in the image data as the digital watermark. Before adding the digital watermark, the image data is subjected to a filtering process according to the equation below, thereby to eliminate the cyclic component of 80 cpi or more in the image data in which the digital watermark is to be embedded:

$${P}^{′} ( i , j ) = {\sum }_{i0 = - 1 , j0 = - 1}^{1 , 1} w ( i + i0 , j + j0 ) \cdot P ( i + i0 , j + j0 ) / {\sum }_{i0 = - 1 , j0 = - 1}^{1 , 1} w ( i + i0 , j + j0 )$$

where P is a pixel value before processing, P′ is a pixel value after processing, and w is a filtering coefficient. For instance, “1” is used in the calculation only where i0:0, j0=0, and “0.25” is used in other cases.

The watermark adding section 102 adds a digital watermark to still image data that is pre-processed in the pre-process section 101. Thereby, the watermark extraction section 103 can extract the digital watermark.

As has been described above, according to the first embodiment, a frequency component in a high region, that is, a frequency component corresponding to a region of a frequency component, which is to be embedded in object image data, is eliminated in advance. Thereby, only the added digital watermark can be extracted without a read error.

A second embodiment of the invention will now be described.

FIG. 7 shows a structure for executing reading of a digital watermark by an image processing apparatus according to a second embodiment of the invention. The image processing section comprises an input/output device select section 401, a watermark adding section 402, a printer output section 403, a scanner input section 404 and a watermark extraction section 405. In the structure shown in FIG. 7, image data, in which a digital watermark is embedded, is output as a hard copy using an output device such as a printer. The digital watermark on the hard copy printed out by the printer is read using an input device such as a scanner.

The input/output device select means 401 is a control panel, etc. As will be described later in detail, the input/output device select means 401 is a select means for selecting an output device, etc.

The watermark adding section 402 adds a digital watermark to image data.

The printer output section 403 is an output device (output means), which outputs image data as a hard copy.

The scanner input section 404 is an input device (input means), which reads a digital watermark.

The watermark extraction section 405 extracts a digital watermark. For example, a selection section, in which output devices are grouped, is provided on the input/output select means 401 such as a control panel. The selection section indicates typical models of the respective groups of output devices. One of the groups is manually selected.

The watermark adding section 402 alters a frequency component to be added, in accordance with the select result on the input/output device select means 401.

The switching of the frequency in the watermark adding section 402 is performed on the basis of a printer resolution to be used and a pattern to be used for tone expression.

Assume, for example, that all frequencies to be embedded are set as shown in an example of arrangement shown in FIG. 8. Region 1 and region 2 may be switched between the case of using a printer with not so high resolution, and the case of using a printer with high resolution but with a tone pattern having a cyclic component in a main scan direction.

As has been described above, according to the second embodiment, a frequency component that cannot be printed by the output means, or a frequency component that cannot be used because a specific direction and a specific frequency are used for tone expression, is not embedded as a digital watermark. This reduces such a possibility that an embedded digital watermark is degraded by the output device, etc. or a component that is not embedded is erroneously extracted.

A third embodiment of the invention will now be described.

The third embodiment relates to a method, different from the method in the second embodiment, for switching the digital watermark process in accordance with characteristics of the input/output device to be used.

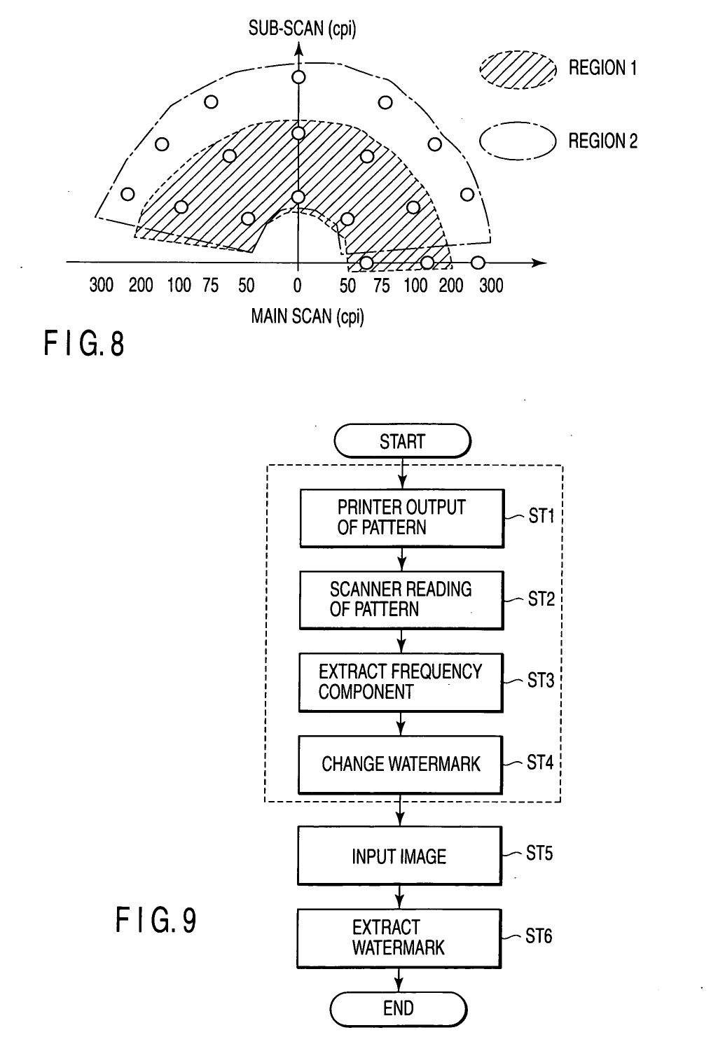

The operation for switching the digital watermark process according to the third embodiment is described referring to a flow chart of FIG. 9.

To start with, a step-chart test pattern including an intermediate level, which is suitable for easy analysis of tone expression, is generated at the time of initial setting (ST1). The test pattern is read by a scanner, etc. (ST2). Then, a frequency component is extracted (ST3), and a digital watermark is changed (ST4). An image is input (ST5) and the digital watermark is extracted (ST6). The process in a block indicated by a broken line (steps ST1 to ST4) is executed only at the time of start-up.

To be more specific, the watermark adding section 402 is set in advance so as to avoid embedding of a frequency component, which may cause a reading error if a digital watermark is added, in consideration of the Nyquist frequency of the output device that is used, the pattern used for tone expression and the resolution and noise characteristics of the input device.

As has been described above, according to the third embodiment, the above-described process is executed in advance. Thereby, it becomes possible to add a digital watermark that is not affected by the characteristics of the employed input/output device and does not cause a reading error.

It should suffice if the adjustment with use of the test pattern is performed only once after at least one of the input device and output device is changed. Thereby, a proper process can be carried out even without making designation each time on the input/output device select means 401, as in the second embodiment, or even without recognizing the model name or performance of the device.

A fourth embodiment of the invention is described.

In the preceding embodiments, the optimal process is executed by recognizing or measuring in advance the characteristics of the input/output device that is used.

In the fourth embodiment, the model names of typical devices, which are widely marketed and whose characteristics are known, are explicitly indicated in advance on the input/output device select means 401. Such names are grouped and displayed. One of the groups is selected, and the digital watermark embedding process is switched according to the result of selection, as described above.

As has been described above, according to the fourth embodiment, the above-described selection and process are performed. Thereby, even the user who is unfamiliar with the device can execute an optimal digital watermark embedding process with less possibility of erroneous reading.

As described above, according to the embodiments of the invention, in the case where an original to be processed has image data with such a characteristic as to cause erroneous reading of embedded information, this characteristic is made less recognizable and then the digital watermark is added. Thereby, the possibility of erroneous reading is minimized, and additional information can be added without restricting the range of the information.

In particular, there is a case where image data, in which a digital watermark is embedded, is output as a hard copy using, e.g. a printer and the image data is input using, e.g. a scanner and then the digital watermark is read. Even in such a case, the digital watermark to be added is altered in advance in accordance with the characteristics of the output device and input device, which are used for the process. This can reduce the possibility of degradation of the digital watermark due to the input/output device and the possibility of erroneous reading due to a confusion between the pattern for use in tone expression of the output device and the digital watermark.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image processing method for adding information to image data, comprising:
subjecting the image data to a predetermined process in accordance with a characteristic of the information, before the information is added;
adding the information to the image data that has been subjected to the predetermined process; and
extracting the information from the image data to which the information has been added.

2. The image processing method according to claim 1, wherein the information is a frequency component.

3. The image processing method according to claim 1, wherein the predetermined process is a process for varying a response by frequency.

4. The image processing method according to claim 1, wherein the predetermined process eliminates, from frequency characteristics of the image data, a frequency characteristic that is possibly confused with the information.

5. An image processing method for adding information to image data, comprising:
altering a process for adding the information in accordance with characteristics of at least one of output means of the image data and input means of the image data.

6. The image processing method according to claim 5, wherein at least one of the output means and the input means is selected by selection means, and
a process for adding the information is performed in accordance with characteristics of the selected output means or the selected input means.

7. The image processing method according to claim 5, wherein a resolution, and a tone pattern cycle and direction of at least one of the output means and the input means are selected by selection means.

8. The image processing method according to claim 5, further comprising:
printing out a test pattern in advance by output means that is used;
reading the test pattern by input means; and
altering a process for adding the information in accordance with a result of reading.

9. The image processing method according to claim 8, wherein the test pattern is a patch or a tone pattern, which includes at least an intermediate level.
